(19) United States
(12) Patent Application Publication
(10) Pub. No.: US 2006/0175004 A1
(43) Pub. Date: Aug. 10, 2006

(54) Process for welding of thermoplastic resins

(76) Inventors: Yasuo Kurosaki, Kanagawa (JP); Tomoya Matayoshi, Chiba (JP); Kimitoshi Satoh, Ibaraki (JP); Mamoru Kagami, Chiba (JP); Takayuki Kajihara, Chiba (JP); Hiroshi Tanaka, Chiba (JP)

Correspondence Address: GIBBONS, DEL DEO, DOLAN, GRIFFINGER & VECCHIONE, 1 RIVERFRONT PLAZA, NEWARK, NJ, 07102-5497, US

(21) Appl. No.: 10/494,637

(22) PCT Filed: Nov. 7, 2002
(86) PCT No.: PCT/JP02/11600

§ 371 Date: Jul. 1, 2004

(30) Foreign Application Priority Data
Nov. 7, 2001 (JP) 2001-341619
Nov. 21, 2001 (JP) 2001-355817

(51) Int. Cl. B32B 37/00

(52) U.S. Cl. 156/272.8

(57) ABSTRACT

Weld bead of excellent surface features with high welding strength can be obtained without development of significant shrinkage and thermal damages.

### TECHNICAL FIELD OF THE INVENTION

The present invention relates to method for welding overlapped thermoplastic resin castings, and more particularly relates to method for welding at least two overlapped thermoplastic resin castings via infrared irradiation.

### BACKGROUND OF THE INVENTION

In welding of at least two thermoplastic resin castings such as resin films, it is highly required to obtain excellent surface features of the weld bead within a short processing period without development of any undesirable thermal damages such as burn, pyrolysis and perforation. To this end, it is advantageous to heat the overlapped castings in a manner to develop a high temperatures region necessary for welding near the weld surfaces within a short period. For such efficient surface heating a number of welding methods such as ultrasonic welding, high frequency welding and infrared welding have conventionally been developed.

In ultrasonic welding process, ultrasonic energy generated by an ultrasonic oscillator is converted into frictional heat via mechanical vibration at weld surfaces, thereby selectively welding only the vicinity of the weld surface via heat generation. When the material to be welded is a soft resin, however, ultrasonic energy is considerably attenuated before transmission to the weld surface and, as a consequence, welding cannot be performed sufficiently in most cases.

In high frequency process, resin castings clamped by a metallic high frequency oscillation die and a supporter instantaneously generate heats and are welded together via dielectric loss. In this case, the high frequency oscillation die is made of high thermal conductivity metallic material and the heat near the surface layer of the welded thermoplastic resin films is removed efficiently to maintain the surface layers of the resin films at a low temperature. As a consequence, development of the above-described thermal damages is well suppressed and surface features of the weld surface are rather unchanged even after the welding process.

This method is suited for processing resins of high dielectric loss such as polyvinyl chloride, polyvinylidene chloride, polyvinyl alcohol and nylon resins but quite unsuited for processing resins of low dielectric loss such as polyethylene, polypropylene, polystyrene, polyester and fluorine resins.

Infrared welding process utilizes infrared as a heat source and is used for welding of combination of a resin of high infrared transmission with a resin of very low infrared transmission, i.e. high infrared absorption. In the following description, these resins are called “transmissive resin” and “absorptive resin”, respectively. More particularly, a transmissive resin casting and a absorptive resin casting are overlapped to each other, infrared is irradiated towards weld surfaces from the transmissive resin side and only the vicinity of the weld surfaces is heated for welding via heat generation caused by infrared absorption by the absorptive resin. This process is disclosed in Japanese Patent Opening 2000-218698 and WO02/00144A1.

In the case of this process, a semi-conductor laser of 0.8 to 0.96 μm wavelength or Nd doped YAG laser of 1.06 μm is used as an infrared source.

As the resins, resin of high inherent infrared absorption or resin including inorganic pigment of high infrared absorption such as carbon black or organic pigments of cyanine group is generally used for the castings. Thus resins of high infrared absorption in the infrared wavelength band are subjected to heating. This process necessitates use of a combination of infrared transmissive resin with infrared absorptive resin and the transmissive resin casting needs to be directed towards the infrared source, thereby unavoidably limiting choice of the material and freedom in processing conditions.

A new process is disclosed in Japanese Patent Opening 2000-71334 in which an infrared transmissive plate is attached to the side to be exposed to infrared irradiation and the plate is removed after welding and coagulation of the resin.

In the case of this process, pressure can be applied to the welded region by the attached plate, the welded region is high in strength and deformation of the welded region is small. This process, however, is based on welding at an abutting region and rather limited in the shape of the castings to be welded together. In addition, since even the surface region is welded, deformation of the surface features is unavoidable.

Another process is also disclosed in Japanese Patent Publication Hei. 6-8032 in which a infrared transmissive solid body is brought into pressure contact with a thermoplastic resin casting on the infrared irradiation side and, in that arrangement, infrared is irradiated towards weld surfaces from the side of the solid body.

In the case of this process, at least one of the resin castings needs to include heating medium at direct heating of the weld surfaces for welding and, as a consequence, this process is quite unsuited for medical applications which is in general vulnerable to inclusion of additives.

Further, Japanese Patent Opening Hei. 10-166451 discloses a new process in which air is blown to the surface of thermoplastic resin casting to suppress melting of the resin casting. This prior art, however, is quite silent as to the manner of control of various regions within the system via infrared irradiation, enhancement of infrared energy and high speed welding.

### SUMMARY OF THE INVENTION

The present invention is based on a finding that a resin weld bead with high weld strength and excellent surface features without development of any thermal damages can be obtained by controlling the surface temperature of a thermoplastic resin casting on the infrared incident side at or lower than the softening temperature of the thermoplastic resin used for processing.

The present invention is characterized by the following features (1) to (7).

According to feature (1), at least two infrared absorptive thermoplastic resin castings are brought into contact and infrared is irradiated to the resin casting for welding of the resin castings. In this process, a thermoplastic resin casting A and a thermoplastic resin casting B are brought in contact, infrared is radiated from the side of the resin casting A, and the relevant process temperatures are controlled in accordance with the following formulas;
Ts<Tma
Ti≧Tm
wherein Ts is the surface temperature of the resin casting A on the infrared irradiation side, Tma is the softening temperature of the resin casting A, Ti is the temperature of the weld surfaces of the resin casting A and B, and Tm is the softening temperature of the resin casting of the lowest softening temperature.

According to feature (2), the resin casting A, the resin casting B and a heat releasing material C having an infrared transmissive region and selected from a solid or liquid material are brought into contact in the order of C/A/B and infrared is irradiated from the side of the heat releasing material C.

According to feature (3), infrared irradiation conditions are controlled in accordance with the following formula when the heat releasing material C is removed;
Ts₂>Ti₂≧Tm
wherein Ts₂ is the surface temperature of the resin casting A on the infrared irradiation side when the heat releasing material C is removed, Ti₂ is the temperature of the contact region of the resin casting A and B and Tm is the softening temperature of the lowest softening temperature resin casting.

According to feature (4), the control of feature (2) or (3) is performed when the heat releasing material C has a solid infrared transmissive region.

According to feature (5), the thermal conductivity of the heat releasing material C at 27° C. is 10 W/m·° C. or higher.

According to feature (6), the infrared is a beam generated by a carbonic acid gas laser.

According to feature (7), the resin castings A and B do not include infrared absorptive heating assistants.

In accordance with the infrared welding method of the present invention, no thermal damages are developed at welding of the infrared absorptive resin casting, thereby providing excellent surface appearance, high strength welded region. As a consequence, the method is rich in all-purpose applications whilst affording high degree of industrial utilization.

### BRIEF DESCRIPTION OF THE DRAWINGS

FIG. 1 is a schematic view of the temperature distribution in one embodiment of the infrared welding method in accordance with the present invention,

FIG. 2 is a schematic view of one embodiment of the infrared welding device in accordance with the present invention,

FIG. 3 is a perspective view of the carbonic acid gas laser welding device used for the examples of the method of the present invention,

FIG. 4 is a perspective view of the carbonic acid gas laser welding device used for the comparative examples,

FIG. 5 is a microscopic representation of the carbonic acid gas laser beam irradiation side surface in example 1 of the present invention,

FIG. 6 is a microscopic representation of the carbonic acid gas laser beam irradiation side surface in comparative example 1,

FIG. 7 is a graphical representation of the carbonic acid gas laser beam irradiation side surface features in example 1 of the present invention,

FIG. 8 is a graphical representation of the carbonic acid gas laser beam irradiation side surface features in comparative example 1,

FIG. 9 is a microscopic representation of the carbonic acid gas laser beam irradiation side surface in example 2 of the present invention,

FIG. 10 is a microscopic representation of the carbonic acid gas laser beam irradiation side surface in comparative example 2 (laser output=1.5 W, mobile speed=2 mm/sec),

FIG. 11 is a microscopic representation of the carbonic acid gas laser beam irradiation side surface in comparative example 2 (laser output=0.6 W, mobile speed=0.2 mm/sec),

FIG. 12 is a graphical representation of the carbonic acid gas laser beam irradiation side surface features in example 2 of the present invention,

FIG. 13 is a graphical representation of the carbonic acid gas laser beam irradiation side surface features in comparative example 2 (laser output=1.5 W, mobile speed=2 mm/sec),

FIG. 14 is a graphical representation of the carbonic acid gas laser beam irradiation side surface features in comparative example 2 (laser output=0.6 W, mobile speed=0.2 mm/sec),

FIG. 15 is a microscopic representation of the carbonic acid gas laser beam irradiation side surface in example 3 of the present invention,

FIG. 16 is a microscopic representation of the carbonic acid gas laser beam irradiation side surface in comparative example 3 (laser output=2 W, mobile speed=2 mm/sec),

FIG. 17 is a microscopic representation of the carbonic acid gas laser beam irradiation side surface in comparative example 3 (laser output=1.5 W, mobile speed=0.2 mm/sec),

FIG. 18 is a graphical representation of the carbonic acid gas laser beam irradiation side surface features in example 3 of the present invention (laser output=12 W, mobile speed=2 mm/sec),

FIG. 19 is a graphical representation of the carbonic acid gas laser beam irradiation side surface features in comparative example 3 (laser output=2 W, mobile speed=2 mm/sec),

FIG. 20 is a graphical representation of the carbonic acid gas laser beam irradiation side surface features in comparative example 3 (laser output=1.5 W, mobile speed=0.2 mm/sec),

FIG. 21 shows the trajectory followed by the carbonic acid gas laser beam performed in example 6 of the present invention,

FIG. 22 is a perspective view of the welding device used in examples 7 to 9 of the present invention,

FIG. 23 is a perspective view of the welding device used in comparative examples 4 to 9,

FIGS. 24A to 24C are photographic representations of the welding regions of a soft polyolefin tube and a polyolefin resin casting.

### BEST EMBODIMENTS OF THE PRESENT INVENTION

In the basic concept of the present invention in which infrared absorptive thermoplastic resin castings A and B are overlapped for infrared irradiation from the resin casting A side, heat generation caused by infrared irradiation and heat release from the resin casting surface are controlled such that regions of a resin casting unrelated directly to welding should not be molten. Stated otherwise, infrared irradiation is controlled in accordance with the following formula;
Ts<Tma
Ti≧Tm
wherein Ts is the infrared irradiation side surface temperature of the resin casting A, Tma is the softening temperature of the resin casting A, Ti is the temperature of the weld surfaces of the resin castings A and B, and Tm is the softening temperature of either the resin casting A or resin casting B.

To this end, intensity of the infrared for irradiation, irradiation time, heat release from the surface of a resin casting opposite to the weld surface and thermal distribution within the resin casting should be carefully controlled. In particular, it is highly important to perform optimum control of the temperature at the weld surface which is related to the surface temperature of the infrared irradiation side resin casting and weldability.

Rise in temperature caused by infrared irradiation is proportional to the amount of infrared absorbed at various regions in a resin casting. The absorptive amount of infrared is correlated to the light absorption coefficient inherent to the intensity of incident infrared and material of the resin casting and follows the Lambert-Beers' law. The amount of infrared absorption per unit volume of the resin casting is largest at the infrared incident surface region and degreases in the inner regions of the resin casting.

The rising speeds of the temperatures at various regions in the resin casting is defined by [(heat quantity to be input into each region per unit volume and unit time)−(heat quantity to be released from each region)]/specific heat. The real temperature, however, is a function of the temperature at each region at initiation of infrared irradiation. As a consequence, the real temperature can be estimated by approximation based on the intensity of infrared irradiation, irradiation time, light absorption coefficient of a resin casting, specific heat, thermal conductivity, heat release from the resin casting and the temperature of each region at initiation of infrared irradiation.

One example of the approximation formula is give below;
∂T/∂t=k/ρc·(∂²T/∂x²)+Q/ρc
Q=|−βl₀exp(−βx)|
wherein T is the temperature, t is the time, x is the distance, k is the thermal conductivity, ρ is the density, c is the specific heat, l₀ is the incident infrared intensity and β is the absorption coefficient.

The formula it a sort of differential equation in which the temperature T at the region of distance x from the surface of the resin casting A indicates the rate of change at the irradiation time t. Using the temperature prior to infrared irradiation as the initial value, the temperature T at the distance x from the surface of the resin casting A can be obtained by approximation.

As a result, the process conditions such as the kind of the resin casting, thickness of the resin casting, infrared irradiation intensity and heat releasing materials for making Ti equal to or higher than Tm and Ts lower than Tma can be easily estimated. Through proper model experiments, the preferable ranges can be determined for the infrared irradiation intensity (unit time, unit cubic angle and infrared energy per unit surface area), irradiation time, temperature at initiation of infrared irradiation, heat release from the surface of the resin casting.

In welding in accordance with the present invention, the process conditions can be controlled such that the regions of a resin casting surface not requiring melting should not be molten.

The method of the present invention will now be explained in more detail in reference to the accompanying drawings.

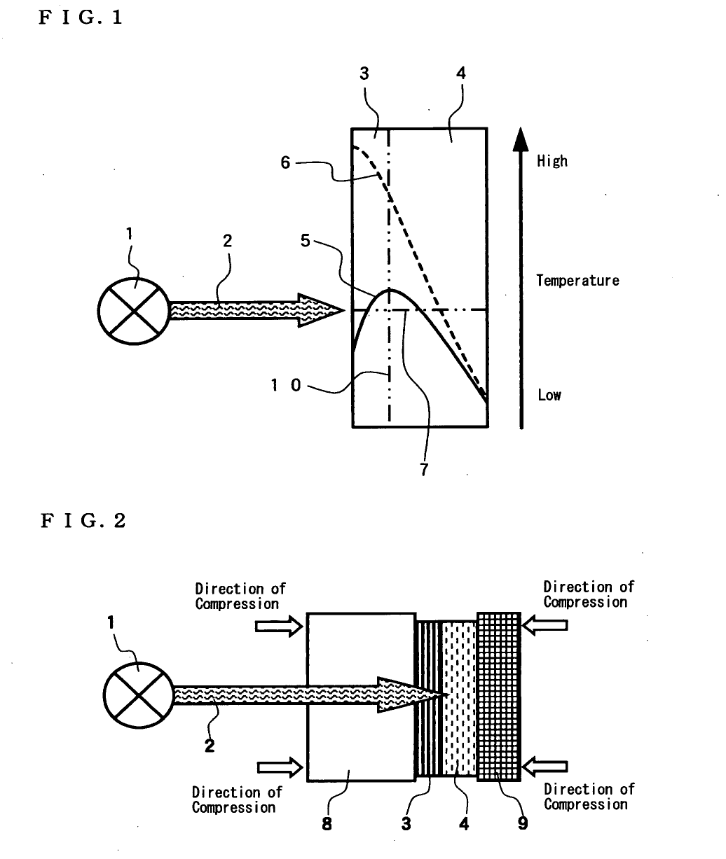

One example of the control of heat release from the surface of a resin casting is shown in FIG. 1. When infrared 2 from a infrared irradiation 1 is irradiated to the resin casting A 3 and resin casting B 4, infrared intensity is controlled on the basis of the light absorption coefficient, specific heat, irradiation temperature and the amount of heat release from the surfaces of the resin castings 3 and 4. Then, the temperature within the resin castings 3 and 4 exhibits a temperature distribution curve 5 such as shown in FIG. 1. The temperature at the weld surfaces of the resin castings 3 and 4 can be controlled equal to or higher than the softening temperatures Tm 7 of the resin castings 3 and 4, and the temperature at the surfaces of resin castings 3 and 4 can be controlled to or lower than the softening temperature Tm.

For example, when the heat release is too small, the temperature of the weld surfaces of the resin castings A and B exhibits the distribution curve 6. Then, since the surface temperature of the resin casting A becomes higher than the softening temperature of the resin casting A, the surface features of the resultant weld bead is degraded due to, for example, thermal damages.

In general, a infrared irradiation source is required to generate infrared of a wavelength in a range from 0.7 to 1000 μm. It is additionally necessary to select a irradiation source which is capable of generating infrared beams of a wavelength and power suited for sufficient heating of the weld surface of the resin casting up to their melting temperatures.

Either infrared lamps or infrared lasers can be used for the infrared irradiation source. As the infrared lamps, halogen or xenon lamps generative of infrared of a wavelength equal to or longer than 0.7 μm are employable. As the infrared lasers, either of solid, semi-conductor, gas, pigment and chemical lasers generative of infrared of a wavelength equal to or longer than 0.7 μm can be used.

More specifically, Nd doped YAG lasers generative of infrared of a wavelength in a range from 0.94 to 1.4 μm can be used for the solid lasers. Whereas, AlGaAs lasers generative of infrared of a wavelength in a range from 0.8 to 0.96 μm can be used for the semi-conductor lasers. Since YAG and semi-conductor lasers of high output (higher than several ten W) are available on the market, these lasers can be used in combination with thermoplastic resin casting of broad infrared absorptive type.

Solid type Ho, Er or Tm doped YAG lasers of an infrared wavelength in a range from 1.9 to 2.94 μm as well as carbonic acid lasers of an infrared wavelength in a range from 9.1 to 10.9 μm, more preferably in a range from 9.3 to 10.6 μm can be preferably used for the infrared irradiation source of the present invention due to their high heating function for high visible light transmissive resins such as polycarbonate resins, polystyrene resins and acrylic resins. In particular, carbonic acid lasers are suited welding in accordance with the present invention due to their high heating function for all sorts of thermoplastic resins and high oscillator output power in a range from several W to several ten kW.

Such infrared irradiation sources are selected in consideration of the type of the thermoplastic resin forming the resin casting, processing temperature in welding and the type of the heat releasing material C.

The infrared output power is selected in accordance with the light absorption coefficient of resin casting, specific heat, irradiation temperature and the range of irradiation. When a heat releasing material is used as described later, high output infrared is employable. More specifically, welding can be performed with use of a heat releasing material at a high infrared irradiation intensity which, without use of such heat releasing material, suffices the following formula;
Ts₂>Ti₂≧Tm
wherein Ts₂ is the infrared irradiation side surface temperature of the resin casting A without use of the heat releasing material C, Ti₂ is the weld surface temperature of the resin casting A and B without use of the heat releasing material C, Tm is the softening temperature of the resin casting of lower softening temperature.

For irradiation of infrared from the source in accordance with the present invention, optical mirrors, fibers, lenses and masks are used for selective irradiation to an extremely micro region, free infrared scanning on a broad surface area of a thermoplastic film and time-sharing control via pulsation. The trajectory and the manner of infrared irradiation can be freely selected depending on the type of application.

In accordance with the present invention, at least two thermoplastic resin castings are used in contact and any type of plastic resins are employable as long as they are infrared absorptive. These resin includes polyethylene, polypropylene, polybutene, poly-4-methyl-1-pentene, polyolefin such as ethylene-cyclic olefin copolymers, ethylene-vinyl acetate copolymers and their saponified derivatives, ethylene-acrylic acid copolymers, ethylene polyethylene terephthalate, polybutylene terephthalate, polyester such as polyethylene naphthalate, polyamides such as nylon 6, nylon 66, nylon 46, nylon 12 and MXD nylon, polymethyl-metha-acrylate, acrylic polymers such as polyacrylic acid, polystyrene, polyacrylonitrile, acrylonitrile-butadiene-styrene copolymers, vinyl chloride, halogen polymers such as polyvinylidene chloride and polyphloroethylene, polybutadiene, synthetic rubbers such as polyisoprene and their hydrogenerated derivative, thermoplastic elastomers such as styrene-butadiene-styrene casting copolymers and their hydrogenerated derivatives, liquid crystal polymers, polyurethane, polycarbonate, polysulphone, polyether ether ketone.

The resin castings to be combined may be either same or different in type and more than 3 resin castings maybe used for welding in accordance with the present invention.

In addition to infrared absorptiveness, the thermoplastic resin used for the present invention is required to have some extent of infrared transmissiveness for successful arrival of effective amount of infrared to weld surfaces.

The resin casting in accordance with the present invention may uniformly include infrared absorptive component or components such as graphite, magnetic iron and carbon black to an amount not impairing the basic purpose of the invention for adjustment of infrared absorption coefficient. For the above reason, however, their content is limited. In most cases, inclusion of such component or components is undesirable from the viewpoints of transparency, safety, strength and hygienic consideration. It is preferable that resin casting itself has an inherent infrared absorptiveness for good generation of heat.

Some colors or pigments may be added to one or more resin castings for improvement in appearance and design. The amount of the colors or pigments is selected so as not to impair the basic object of the present invention, and, more specifically, in a range up to 5 wt %, more preferably up to 3 wt %, and more preferably up to 2 wt %.

The resin castings to which the welding method of the present invention is applied are manufactured by any of the known prior art processes. More specifically, injection molding, blow molding, tube molding, heteromorphic extrusion molding, foam molding, compression molding, calender molding, extrusion molding and cast molding can be used for the manufacture.

The resin castings can be given in any configurations such as films, sheets, tubes and spherical masses. Although the thickness of each resin casting itself is unlimited, the thickness of the infrared irradiation region of a resin casting is preferably in a range from 1 μm to 10 mm, more preferably from 10 μm to 1 mm, from the viewpoint of welding efficiency and weld bead.

The thermoplastic resin casting in accordance with the present invention may be of either single layer or multi-layer construction. In the case of multi-layer construction, the resin casting can be prepared by a known prior art process using extrusion laminates or dry laminates.

The softening temperature of the resin casting in accordance with the present invention refers to a temperature at which the resin is soften or molten. In general, melting point temperatures are employed for crystalline thermoplastic resins whereas glass transition temperatures are employed for non-crystalline thermoplastic resins. Measurement of such temperature is carried out using a differential scanning calorimeter.

When a resin casting is of a multi-layer construction, the softening temperature of the weld surface refers to the softening temperature of the resin forming the weld surface. When the softening temperatures of the weld surfaces of the resin castings in contact are different, the lowest softening temperature is used for the softening temperature Tm given in the claimed formula. The temperature Ti of the weld surface at welding should be equal to or higher than said Tm, preferably equal to or higher than the lowest softening temperature of the resin castings subjected to welding.

In the welding process in accordance with the present invention, the infrared irradiation side surface temperature Ts of resin casting A is controlled below the softening temperature Tma of the resin forming the resin casting A. In the case of a resin casting of a multi-layer construction, the above-described softening temperature refers to the softening temperature of the resin forming the surface region of the resin casting. This surface temperature at welding should preferably be lower than the softening temperature of the resin surface, and more preferably should be a temperature lower by 10 degrees or more than the above-described softening temperature.

It is very important in the infrared welding in accordance with the present invention to properly control the environmental temperature. In general, the lower the environmental temperature, the larger the amount of heat release by resin castings. This procedure is preferable because the surface temperature of the resin casting A is lowered. Excessively low environmental temperature, however, causes generation of thermal stress, thereby leading to breakage of the resin castings A and B during welding. Thus, control of the environmental temperature need to be cried out carefully.

In order to keep the infrared irradiation side surface temperature of resin casting A lower than the softening temperature Tma of the resin forming the resin casting A, it is preferable to increase the amount of heat release by the resin casting A. To this end, it is preferable to bring a gaseous of liquid heat releasing material having a infrared transmissive region into contact with the infrared irradiation side of the resin casting A. Thanks to fluidity of gas and liquid, use of the heat releasing material in fluid state enhances heat-releasing ability.

In accordance with the present invention, gaseous heat releasing material is used in a state of forced convection. Air and inert gases such as nitrogen, argon and helium are used for such heat releasing material. From the viewpoint of safety and cost, air is the most advantageous material. From the viewpoint of high heat release, however, it is preferable to use helium which is high in thermal conductivity. Solid masses and liquid are preferably used due to their large heat capacity and those of high thermal conductivity are more preferably used.

There is no special limit to the period of contact of such heat releasing material C with the resin casting A. The contact may last throughout welding process or only for a short period. Intermittent contact is also employable.

Water is preferably used for the liquid heat releasing material due to its excellent function and cost. Water is an excellent heat releasing material due to its large heat capacity and used in the mode of short period contact, misty spray and intermittent contact in mixture with air. In the case of direct contact of water with the resin casting A, the resin casting should preferably be made of a resin of low welding absorption. Even when water has strong infrared absorption, it can be regarded as infrared transmissive by formation of a thin flow path within the resin casting or increase in thickness by interposition of the liquid between the infrared transmissive region of a sold heat releasing material and the resin casting A. In the former case, high heat release is obtained by increasing the speed of the liquid in the flow path.

Solid infrared transmissive material is preferably used for the solid heat releasing material C. The infrared transmissive material in accordance with the present invention well suppresses overheating of the surface region of the resin casting A to prevent thermal damages on the surface of the weld bead by its heat sink operation which is able to efficiently absorb a part of heat generated by strong infrared absorption at the surface of the resin casting A.

The solid heat releasing material should preferably be resistant against melting and breakage such as generation of cracks caused by heat shock and low in heat storage for easy removal of heat even after repeated use. To this end, the sold heat releasing material should have high degree of infrared transmission, high thermal conduction, high mechanical strength and high thermal resistance. More specifically, the thermal conductivity should be 1 W/m·° C., more preferably equal to or larger than 10 W/m·° C. It is, however, possible to enhance heat release by providing proper heat removing system such as the above-described flow path and contact of metal elements.

Even in the case of a material of relatively low thermal conductivity, sufficient heat removal function can be afforded by increase in thickness of the transmissive body and attachment of a heat removing system. The thickness of the solid heat releasing material in accordance with the present invention should be in a range from 10 μm to 100 mm, more preferably from 100 μm to 100 mm.

The infrared transmissive solid material is basically required to be transmissive to irradiated infrared and, as a consequence, the type of the infrared transmissive solid material varies depending on the wavelength of infrared to be irradiated. It is recommended to use a infrared source selected from a group consisting of halogen or xenon lamps generative of infrared having a wavelength equal to or longer than 0.7 μm, semi-conductor lasers generative of infrared having a wavelength in a range from 0.8 to 0.96 μm, Nd:YAG lasers generative of infrared having a wavelength in a range from 0.94 to 1.4 μm and Ho, Er, Tm generative of infrared of a wavelength in a range from 1.9 to 2.94 μm.

When a YAG laser is used for the infrared source, the solid material should preferably selected from a group consisting of transparent alumina (Al₂O₃, thermal conduction=36 W/m·° C.), transparent beryllia (BeO, thermal conduction=270 W/m·° C.), transparent magnesia (MgO, thermal conductivity=48 W/m·° C.), transparent quartz (SiO₂, thermal conductivity=1 to 10 W/m·° C.) and diamond (thermal conductivity=2000 W/m·° C.).

When transparent quartz is selected, it is highly transparent in the near infrared region but generally low in thermal conductivity. As a consequence, when compared to transparent alumina, transparent beryllia and transparent magnesia, it is high in heat storage during and after infrared irradiation and, as a consequence, rather poor in efficient heat removal. For these reasons, it is preferable to use transparent alumina, transparent beryllia, transparent magnesia and diamond which are rich in thermal conductivity.

When a carbonic acid gas laser is used for the infrared source with an infrared wavelength of 9.1 to 10.9 μm, it is preferable to use a solid heat releasing material selected from a group consisting of zinc selenide (ZnSe, thermal conductivity=19 W/m·° C.), zinc sulfide (ZnS, thermal conductivity=27 W/m·° C.), silicon (Si, thermal conductivity=150 W/m·° C.), gallium arsenide (GaAs, thermal conductivity=54 W/m·° C.) and diamond (thermal conductivity=2000 W/m·° C.).

Other infrared crystal materials and infrared glass materials may also be used as long as they possess infrared transmissiveness, high thermal conductivity, mechanical strength and thermal resistance. Here, the infrared crystal and infrared glass materials refer to crystal inorganic materials and non-crystal inorganic materials surface of the supporter as a sort of mirror for efficient reflection of infrared. Conversely, proper surface treatment may be applied to the resin casting irradiation side surface of the supporter using infrared absorptive paint or for enhancement of infrared absorption.

The supporter may be fitted with a rubber cushion layer on the infrared irradiation side surface. When the resin casting are thin in construction or high in heat shrinkage, likely presence of surface unevenness of the resin casting may lead to insufficient physical contact (contact pressure and contact surface area) of the heat releasing material with the resin castings, thereby generating undesirable defects such as void formation and significant shrinkage. In such cases, presence of the interface rubber cushion layer improves the state physical contact.

The rubber cushion layer should preferably have good heat resistance. One good example is silicon rubber whose shore A hardness should be in a range from 40 to 90 (measured according to the JIS K 6253 standard). The thickness should preferably be equal to or larger than 0.1 mm.

The infrared irradiation side surface layer may have an overlapped combination of a metallic infrared reflective thin layer and a rubber cushion layer. When compared with absence of such a metallic infrared reflective layer, heat generation of the rubber cushion layer due to infrared passed through the resin casting A can be well prevented. It is, however, very important to select a metallic material

Preferable infrared glass material is selected from a group consisting of quartz type glass materials mainly containing quartz (SiO₂), germanate type glass materials mainly containing germania (GeO₂), aluminate type oxidized glass materials mainly containing alumina (Al₂O₃), sulfide type glass materials and chalcogenide glass materials.

Through use of heat releasing material C in accordance with the present invention, high output carbonic acid gas lasers of several W to several ten kW oscillator outputs can be used for the infrared source. When provided with high mechanical strength, the heat releasing material in accordance with the present invention is able to apply pressure to the contact surfaces of the resin castings A and B to maintain stable state of contact whilst well protecting the surface of the resin casting A.

A proper supporter may be used for protection of the resin casting B. During irradiation of infrared, the supporter maintains stable contact the weld surfaces of the resin casting and the heat releasing material and, as long as suited for that purpose, no limitation is imposed on its configuration and quality. For example, metallic blocks or plates made of steel, aluminium alloys and copper alloys are usable for the supporter.

When infrared reaches the supporter through the resin casting, proper re-heating of the weld surfaces is also employable by making the well complementary with the configuration of the resin casting B so as not to impair improvement in physical contact thanks to use of the rubber cushion layer.

Examples of such a metallic infrared reflective thin layer are an aluminium, copper and stainless steel foil of a thickness in a range from 1 to 100 μm. The sold heat releasing material C and the supporter may be fitted with a proper heat removing system in order to efficiently remove heat stored in them due to thermal transmission from the resin castings subjected to infrared irradiation. Conversely, a proper auxiliary heater may be provided to maintain a constant temperature of the system.

For application of pressure, mechanical clamping mechanisms utilizing screw clamps, springs, oil pressure and pneumatic pressure as well as manual clamping mechanisms may be employed to maintain static compression during welding. Dynamic application of compression is also employable in which, in addition to the static compression, heat releasing material and resin casting in contact are subjected to relative movement during irradiation of infrared. The magnitude of such compression is selected such that no defects such as void development and shrinkage formation should be generated after welding due to insufficient compression or no breakage of resin castings should be resulted from excessive compression. The magnitude of compression varies depending on the type of resin casting and welding conditions. In general, the magnitude of compression should preferably be in a range from 0.01 to 10 MPa.

Examples of the weld beads manufactured by the method of the present invention are bags, boxes, tubes and hoses. More specifically, the weld beads are given in the form of a bag type container made of two thermoplastic resin films with welded edges and a container with plastic plugs welded to the mouth. These containers are use, for example, for soft drinks. Welding of the present invention is also used for weld beads of an elongated tube made up of two tubes welded together at their making ends. A container may be fitted with a tube welded to its mouth.

### EXAMPLES

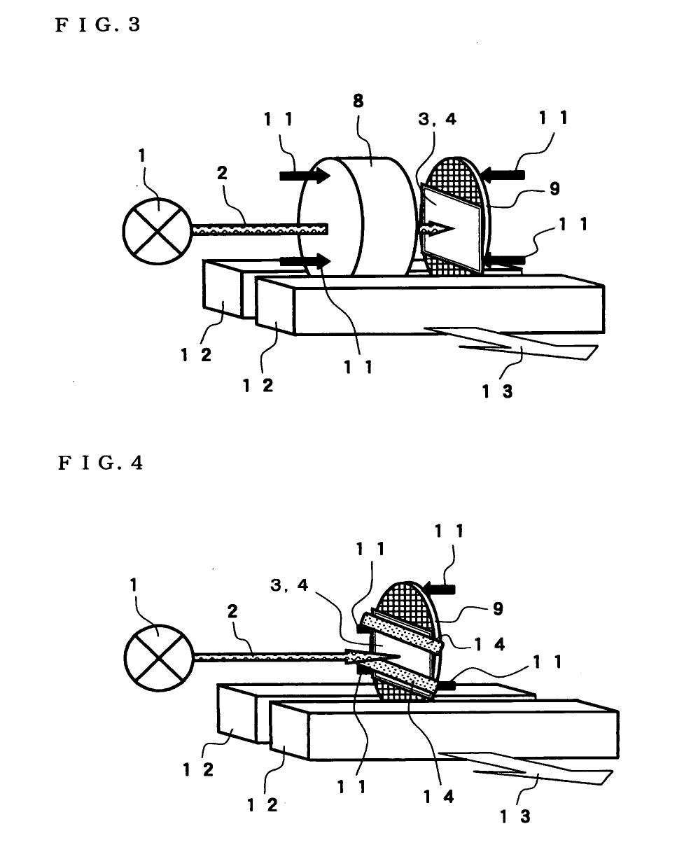

Welding of the present invention was applied to thermoplastic resin films using the experimental device shown in FIG. 3. A carbonic acid gas laser was used for irradiation infrared source 1 with an infrared wavelength of 10.6 μm, the maximum output of 25 W, continuous oscillation and a beam diameter of about 2 mm. A zinc selenide (ZnSe) circular column with a thermal conductivity of 19 W/m·° C., a diameter of 50 mm, a thickness of 20 mm and a carbonic acid gas laser transmittance of 99% was used for the heat releasing material 8 with a double face anti-reflection coating. A brass circular plate with a diameter of 50 mm and a thickness of 2 mm was used for the supporter 9.

To prepare thermoplastic resin castings, two overlapped thermoplastic resin films (35 mm×35 mm) were sandwiched between the above-described zinc selenide circular column and brass circular plate with compression by a screw type clamp at a pressure of about 0.1 MPa. The films were made of a material which was unsuited for welding by the conventional welding process. That is, the material was low in dielectric loss in high frequency band, unsuited for high frequency and ultrasonic welding due to its softness and high in melting point temperature.

The first example of film combination included an olefin type partially cross-linked thermoplastic elastomer film (Mirastomer 6030N by Mitsui Chemicals, Inc.) placed on the infrared irradiation side with a shore A hardness of 60, a melting point temperature of 160° C., a carbonic acid gas laser light absorption coefficient of 6.7×10³ m⁻¹ and a thickness of 600 μm, and a polypropylene film placed on the opposite side with a melting point temperature of abut 130° C., a carbonic acid gas laser light absorption coefficient of 3.1×10³ m⁻¹ and a thickness of 190 μm.

The second example of film combination included two ethylene tetrafluoride-per-phloroalkoxy copolymer (PFA, Neoflon PFA by Daikinkogyo) with a melting point temperature of 305° C., a carbonic acid gas laser light absorption coefficient of 9.0×10³ m⁻¹ and a thickness of 70 μm. The films had same properties and thickness.

The third example of film combination included two high melting point temperature liquid crystal polymer films (LCP, LCP-H1125 by Sumitomokagaku) with low dielectric loss in the high frequency band, a melting point temperature of 330° C., a carbonic acid gas laser light absorption coefficient of 2.7×10⁴ m⁻¹ and a thickness of 25 μm. The films had same properties and thickness.

In comparative examples, a carbonic acid gas laser was used without the heat releasing material 8 shown in FIG. 4, i.e. a solid infrared transmissive material. The following observations were performed regarding welded films.

The surface features of the welded and non-welded regions were evaluated using a digital microscope (digital HF microscope, VH-8000 by Kiience).

The surface unevenness in the thickness direction normal to the film surface including weld bead was measured by using a roughness tester (Tarfcom 1400-3DF by Tokyoseimitsu).

For measurement of the weld strength, a test piece of 15 mm width was taken in a direction normal to weld bead out of a welded film. The test piece was subjected to extension by a tensile tester with an inter-chuck distance of 20 mm and a tensile speed of 300 mm/min. The maximum load leading to breakage was recorded as the weld strength.

### Description of Examples

### Example 1

Films of the above-described first example were used, i.e. an olefin type partially cross-linked thermoplastic elastomer film 3 and a polypropylene film 4. The films were overlapped with the elastomer film on the infrared irradiation side and set to the device shown in FIG. 3. Concurrently with initiation of infrared irradiation, a supporter was moved normal to the direction of irradiation over about 25 mm at a mobile speed of 2 mm/sec to obtain a weld bead. The laser output during welding was about 7 W and the welded films were taken out of the device instantly after the welding. The width of the welded region corresponding to the irradiation beam diameter was about 0.8 mm.

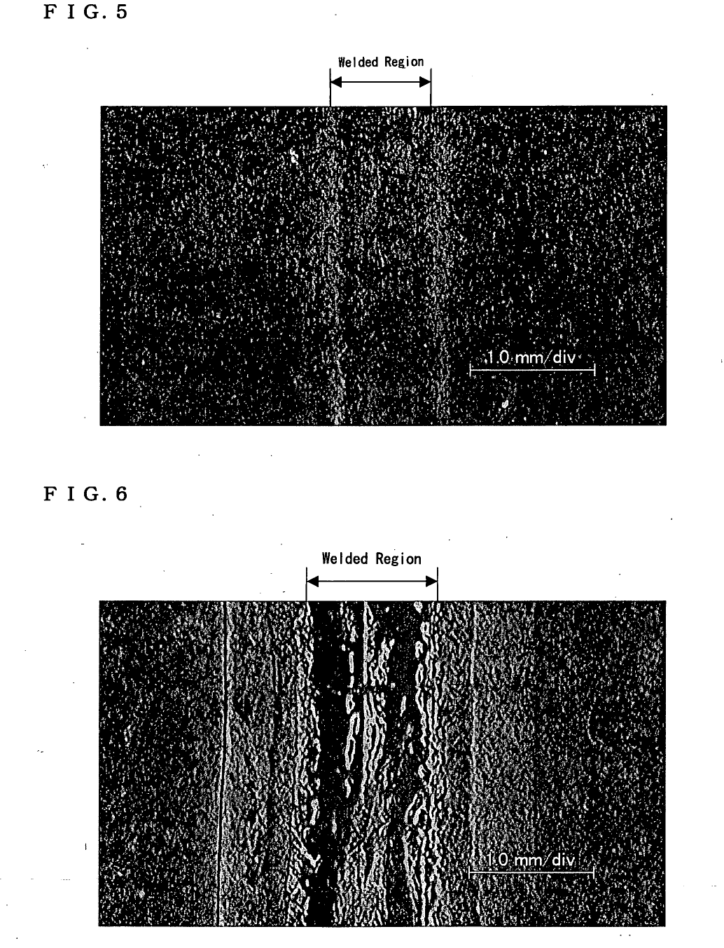

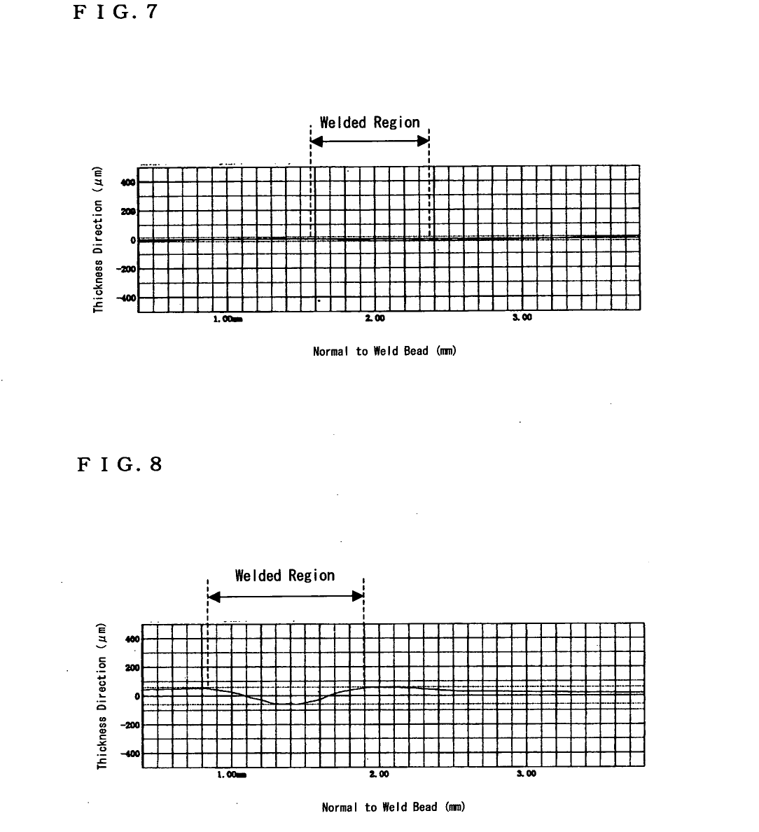

For evaluation of the surface features of the welded region, the surfaces of the welded and non-welded regions were observed using a digital microscope and the result is shown in FIG. 5. The surface unevenness in a direction normal to the weld bead measured by a roughness tester is shown in FIG. 7. The results in FIGS. 5 and 7 indicate the fact that the welded region includes substantially no melting and shrinkage, the smoothness of the welded region is similar to that of the non-welded region and melting and coagulation occurred in the inner regions only.

In fact, visual observation also confirmed transparent and beautiful state of the welded region. The weld strength was 17N/15 mm. During the tensile test, no detachment was observed at the weld interface. It was thus confirmed that use of infrared transmissive solid material in combination with a carbonic acid gas laser affords a weld bead of excellent surface features with sufficient weld strength.

### Comparative Example 1

As shown in FIG. 4, the film combination same as example 1 was used without zinc selenide 8 and irradiation was carried out by a carbonic acid gas laser against the weld surface of the elastomer film 3. Overlapped films were fixed to a supporter 9 via a screw clamp and a resin film fixing plate. A gap of about 5 mm was left between the films and the fixing plate so as make the weld bead the axis of axisymmetric arrangement. Irradiation was performed with a mobile speed of 2 mm/sec and a laser output of from 1 to 7 W.

Smoke was generated from the surface of the elastomer films when the laser output surpassed 1 W. As the laser output surpassed 4 W, the elastomer films broke down and it was quite difficult to weld them successfully. Then, the mobile speed was lowered to 0.2 mm/sec and the laser output was changed for further tests. As the laser output reached 0.6 W, the film surface could be barely welded with generation of some smoke. As shown in FIGS. 6 and 8, the surface features of the irradiated surface was significantly degraded with significant presence of color change and decrease in thickness. The weld strength was 9N/15 mm and detachment at the weld surface was observed during the tensile test. When compared with the results in example 1, the surface features and the weld strength of the welded region were both significantly degraded.

### Example 2

The above-described second film combination was employed with use of ethylene tetrafluoride-per-phloroalkoxy copolymer (PFA). Except use of an output of 6 W, the welding conditions were same as example 1. After welding, the films were instantly taken out of the device. The width of the welded region corresponding to the infrared beam diameter was about 1.4 mm.

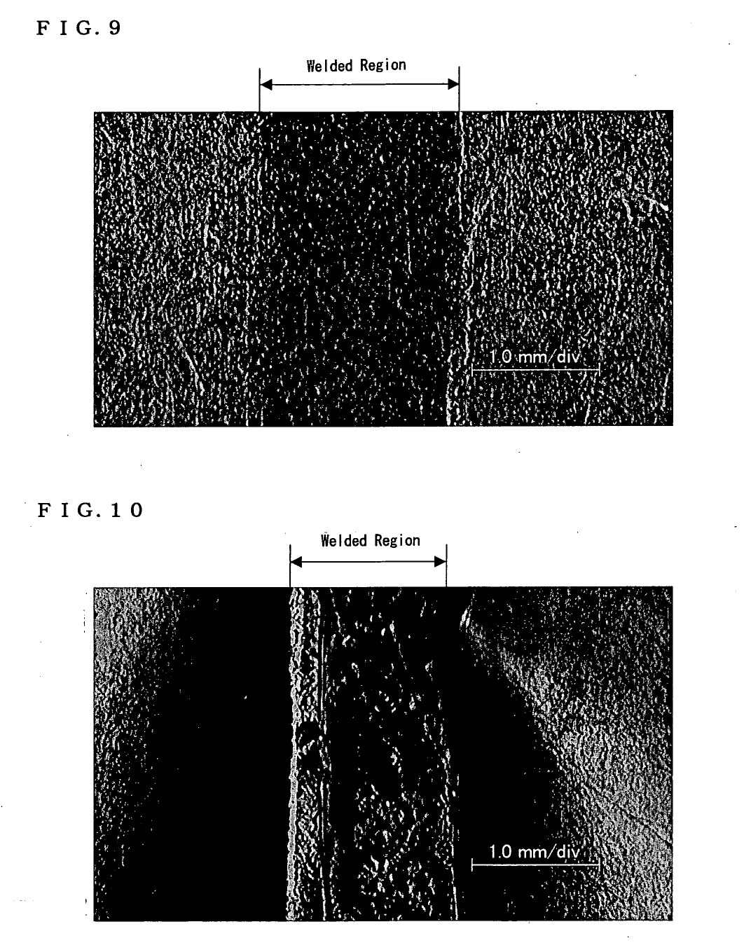

Visual observation confirmed no presence of melting and shrinkage on the film surface, transparent state of the inner regions and substantial absence of change in surface features. It was almost difficult to discriminate the welded and non-welded regions. As shown in FIGS. 9 and 12, the surface smoothness of the welded region was almost same as that of the non-welded region. It is esteemed that melting and coagulation occurred inner regions only. The weld strength was 24N/15 mm and no detachment was observed during the tensile test. Presence of sufficient weld strength was confirmed.

### Comparative Example 2

The film combination similar to that of example 2 was employed except absence of the zinc selenide heat releasing material 8 and direct infrared irradiation was performed by a carbonic acid gas laser. Like comparative example 1, overlapped films were fixed to a supporter via a screw clamp and a resin film fixing plate. Welding at a mobile speed of 2 mm/sec caused generation of smoke at a laser output of 1 W, welding occurred at a laser output of 1.5 W and the film breakage started at a laser output over 2 W.

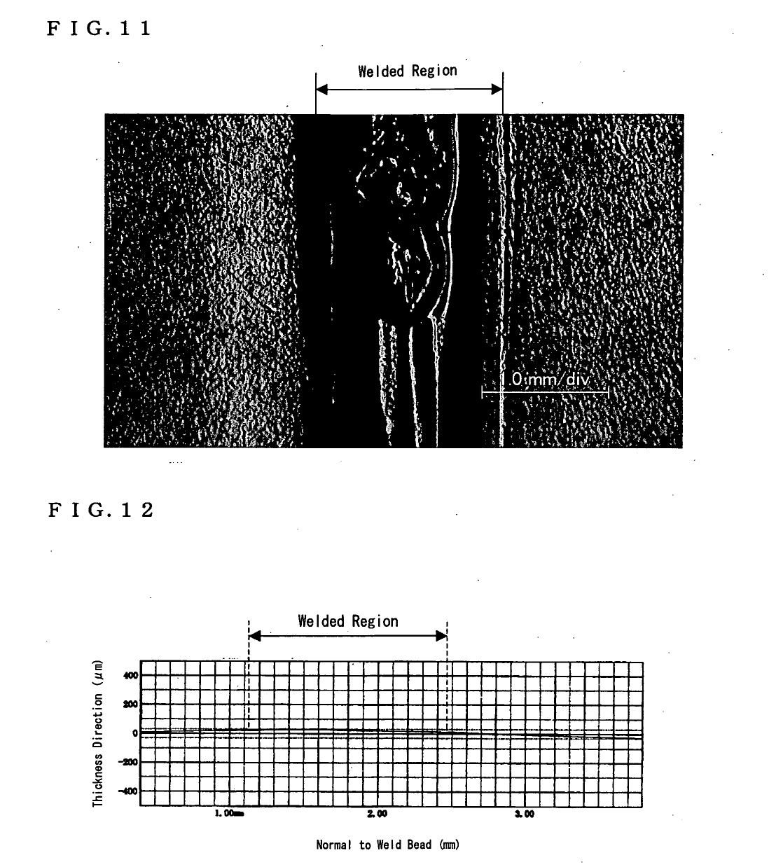

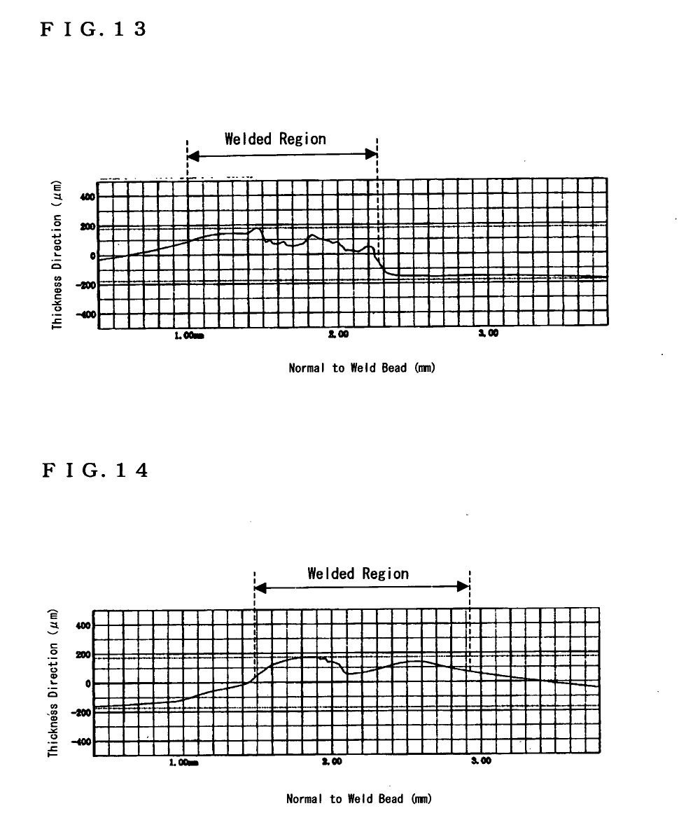

The surface features of the welded region of the films are shown in FIGS. 10 and 13, wherein the welded region was more uneven than the non-welded region and significant shrinkage was observed. The weld strength was 19N/15 mm. Then, the mobile speed was lowered to 0.2 mm/sec and the laser output was changed. The films were barely welded at a laser output of 0.6 W but significant shrinkage was observed as shown in FIGS. 11 and 14. The weld strength was 18N/15 mm. Further rise in laser output caused generation of smoke and partial breakage at a laser output over 0.8 W. No welding could be carried out at higher laser outputs. The surface features and the weld strength were both degraded from those in example 2.

### Example 3

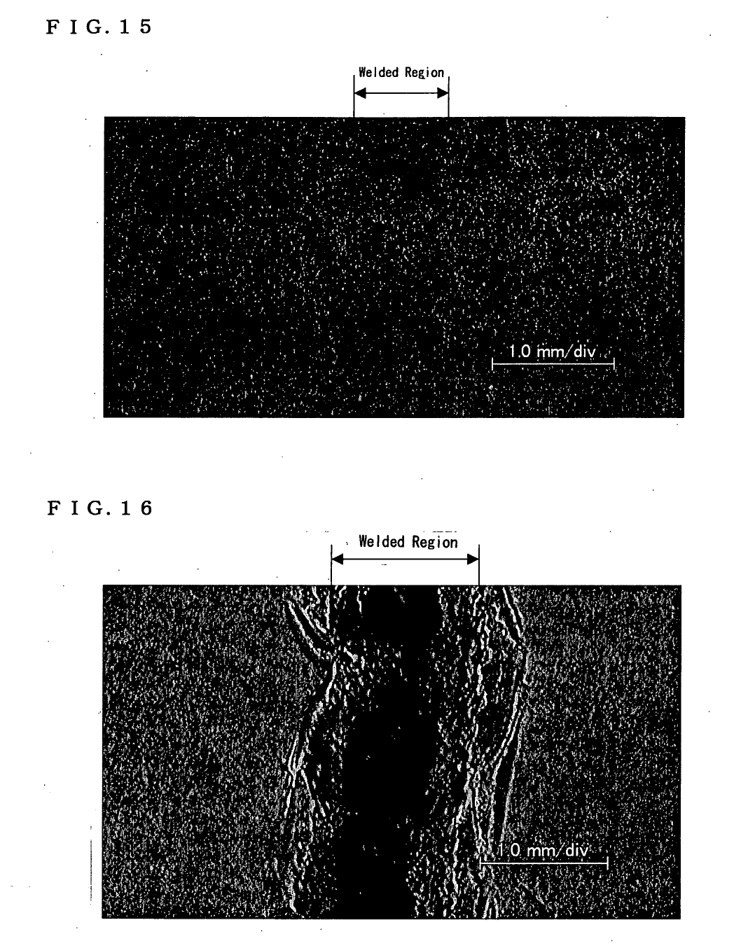

The third film combination was employed, i.e. liquid crystal polymer (LCP) films. The welding conditions were same as those in example 1 except a laser output of 12 W. The films were taken out of the device instantly after welding and width of the welded regions corresponding to the carbonic acid gas laser beam diameter was about 0.8 mm. Visual observation confirmed full absence of surface melting and shrinkage. The change in surface features was very small and discrimination between the welded region and the non-welded region was quite difficult. As shown in FIGS. 15 and 18, it is esteemed that infrared irradiation caused melting and coagulation in the inner regions only. The weld strength was 3N/15 mm and welding was performed maintaining of good surface features.

### Comparative Example 3

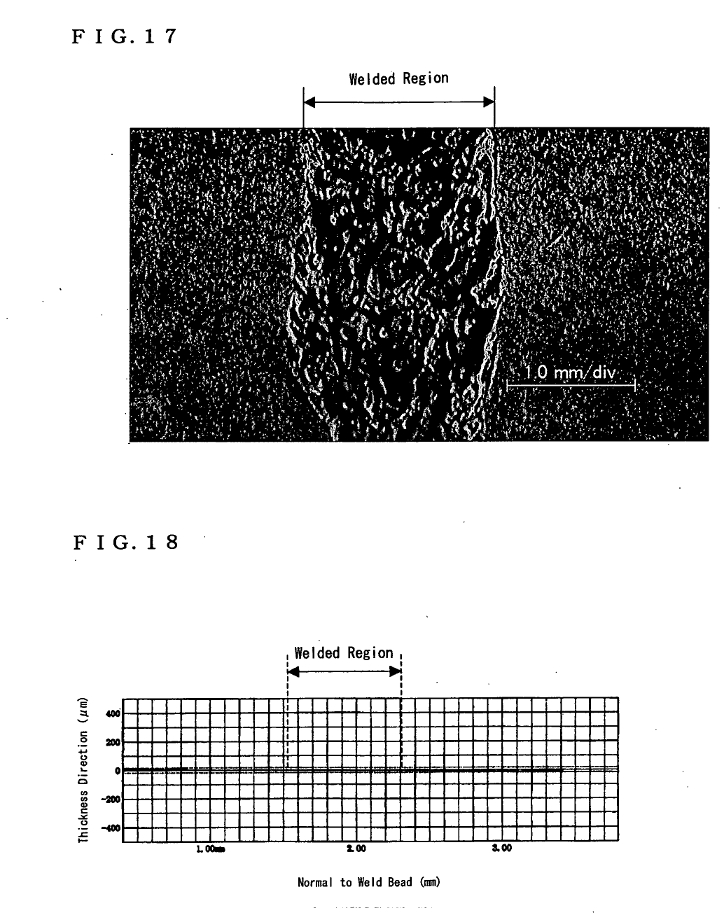

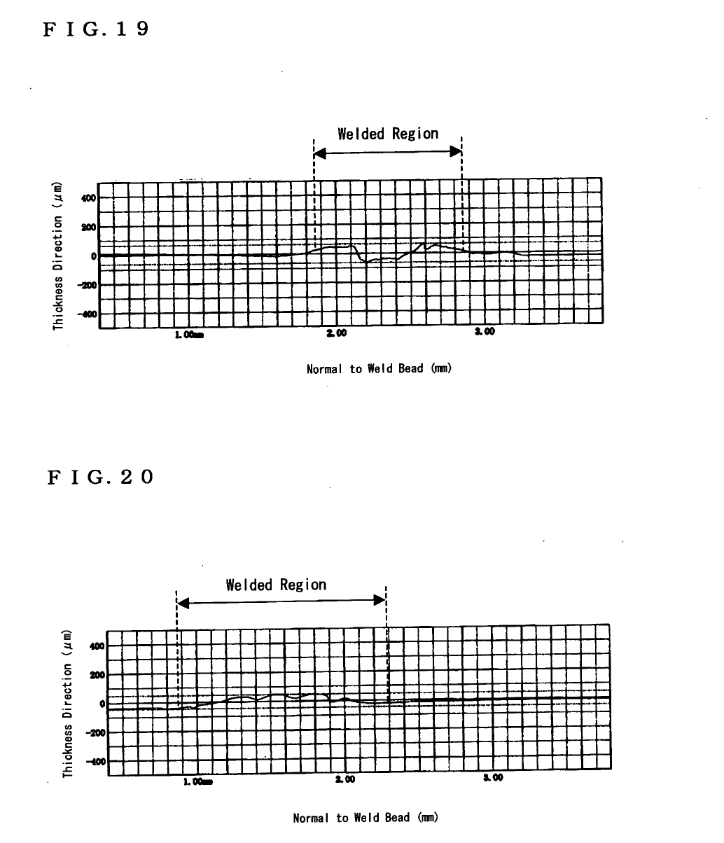

A film combination similar to that in example 3 was employed except absence of zinc selenide heat releasing material 8. Like comparative example 1, overlapped films were fixed to a supporter 9 via a screw clamp and a resin film fixing plate. With a mobile speed of 2 mm/sec, laser output over 1 W caused generation of smoke from the surface of the films and welding could be barely performed at a laser output of 2 W. As shown in FIGS. 16 and 19, significant roughness was generated on the welded surface and the weld strength was as low as 1N/15 mm. Then the mobile speed was lowered to 0.2 mm/sec and laser output was changed. A laser output of 1.5 W barely enabled welding. As shown in FIGS. 17 and 20, the welded surface was degraded as in the case of the mobile speed of 2 mm/sec. The weld strength was 2N/15 mm. It was fully difficult to perform stable welding with maintenance of good surface features.

### Example 4

The device shown in FIG. 3 was used with an exception that the zinc selenide circular column was replaced by a silicon circular plate of a thermal conductivity of 150 W/m·° C. at 27° C., a diameter of 50 mm, a thickness of 2 mm and a carbonic acid gas laser transmittance of 60% and anti-reflective coating was applied to the infrared irradiation side surface. Two films 3 and 4 of the following five layer construction were overlapped each having 35×35 mm dimension and 150 μm thickness. The first, third and fifth layers were made of ethylene-α-olefin copolymer (Ultozex 2021L by Mitsui Chemicals, Inc.) of a density of 922 kg/m³, a MFR (190° C.) of 2.0 g/10 min, a melting point temperature of 120° C. and a carbonic acid gas laser light absorption coefficient of 1.1×10³ m⁻¹.

The second and fourth layers were made of ethylene-α-olefin copolymer (TafumarA-1085 by Mitsui Chemicals, Inc.) of a density of 885 kg/m³, a MFR (190° C.) of 1.2 g/10 min, a melting point temperature of 74° C. and a carbonic acid gas laser light absorption coefficient of 1.3×10³ m^{-1.}

After film overlapping, the films were inserted between the above-described silicon circular plate and a brass circular plate. A screw clamp was used to maintain a compression of about 0.1 MPa. Concurrently with initiation of infrared irradiation, the holder was moved normal to the infrared irradiation direction at a mobile speed of 10 mm/sec over about 25 mm to obtain a weld bead. The laser output was 13 W. Instantly after infrared irradiation, the welded films were taken out of the device and the width of the welded region corresponding to the irradiation beam diameter was about 2 mm. The welded region had sufficient strength, smoothness roughly same as the non-welded region and excellent appearance. The welding method of the present invention assures excellent welding with beautiful surface appearance and absence of thermal damages on the welded region even in the case of films of a multi-layer construction.

### Example 5

The film combination employed included five films of same type for confirmation of welding results. The device shown in FIG. 3 was used with the exception that the zinc selenide circular column was replaced by a quartz glass circular plate of a diameter of 50 mm, a thickness of 7 mm and a thermal conductivity of 1.2 W/m·° C. at 27° C. and the carbonic acid gas laser was replaced by continuous oscillation type a semi-conductor laser of a source wavelength of 0.808 μm and a beam diameter of 1 mm. The film combination included polypropylene films of a melting point temperature of 130° C., inclusion of green pigment, a dimension of 35×35 mm, a thickness of 190 μm and a semi-conductor laser light absorption coefficient of 2.3×10³ m⁻¹.

Overlapped five films were inserted between a quartz circular plate and a brass circular plate and compression of about 0.1 MPa was maintained by a screw clamp. Concurrently with initiation of welding irradiation, the holder was moved normal to the direction of irradiation at a mobile speed of 6 mm/sec over about 25 mm to obtain a weld bead. The laser output was 5 W. Instantly after irradiation, the welded films were taken out of the device and the width of the welded region corresponding to the beam diameter was about 1 mm. The overlapped five films were sufficiently welded, no melting and shrinkage were present on the welded surface, the smoothness of welded region was same as that of the non-welded region and the surface features were very excellent. The welding method of the present invention enabled good welding with beautiful surface appearance of the welded surface and no presence of melting and shrinkage on the welded surfaces.

### Example 6

In this example, welding was carried out with a higher infrared intensity and a higher speed and infrared beam was irradiated scanning in a horizontal plane. Free bead shapes such as straight lines and curves were formed within the plane of a thermoplastic film.

A carbonic acid gas laser of 10.6 μm wavelength and 6 mm beam diameter was used for the infrared source, a silicon circular plate of a thermal conductivity of 150 W/m·° C. at 27° C., a diameter of 305 mm, a thickness of 775 μm and a carbonic acid gas laser transmittance of 50% was used for the solid heat releasing material 8 and a steel rectangular plate of 300×300 mm dimension and a thickness of 10 mm was used for the supporter.

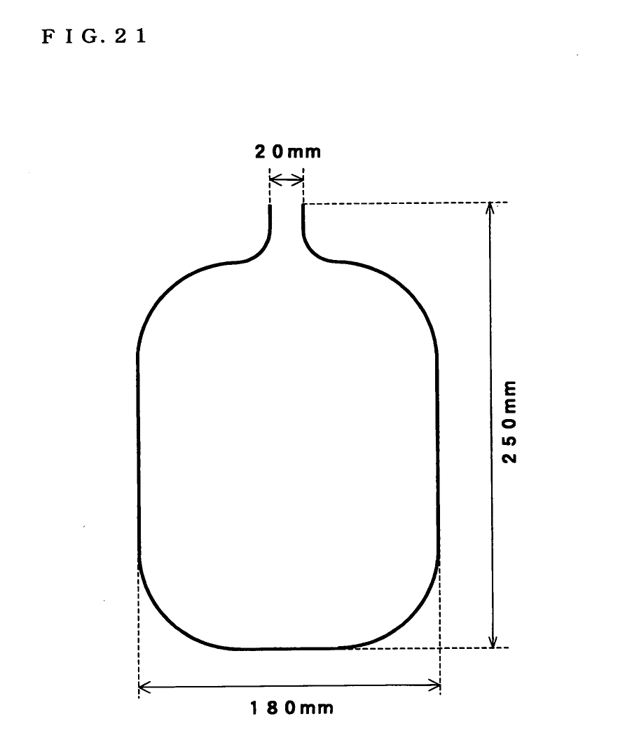

Film combination included two low density polyethylene films of a melting point temperature of 120° C., 300×300 mm dimension and a thickness of 240 μm. From the lower side, the supporter 9, the polyethylene films 3 and 4 and the silicon circular plate were overlapped in the described order. A steel ring of 2 kg weight was fitted to the periphery of the silicon circular plate for application of compression between the supporter 9 and the silicon circular plate 8. A constant laser output was set in a range from 400 to 700 W. Beam irradiation was directed perpendicularly downwards to the weld region. The beam scanned the weld region at a constant speed of 100 mm/sec along the trajectory shown in FIG. 21. Instantly after irradiation, the films were taken out of the device.

It was confirmed that a weld bead of a shape corresponding to the trajectory shown in FIG. 21 was obtained. When the laser output was at 700 W, the width of the welded region corresponding to the beam diameter was about 6 mm. The welded surfaces included no melting and thermal damages. By infrared scanning at with a high infrared intensity and at a high speed, a welded region having a free bead shape within the plane of the films and excellent surface features could be obtained.

### Examples 7 to 9

As one application of the present invention, welding of partially tubular thermoplastic resin castings was performed. The resin casting combination included a soft polyolefin resin casting 3 and a polyethylene resin casting 4. Since the soft polyolefin resin casting was tubular in shape, it was difficult to apply welding such as heat sealing and impulse sealing. So one tubular region is inserted at one end to the other tubular region and welding was applied to the circumference of the inserted regions.

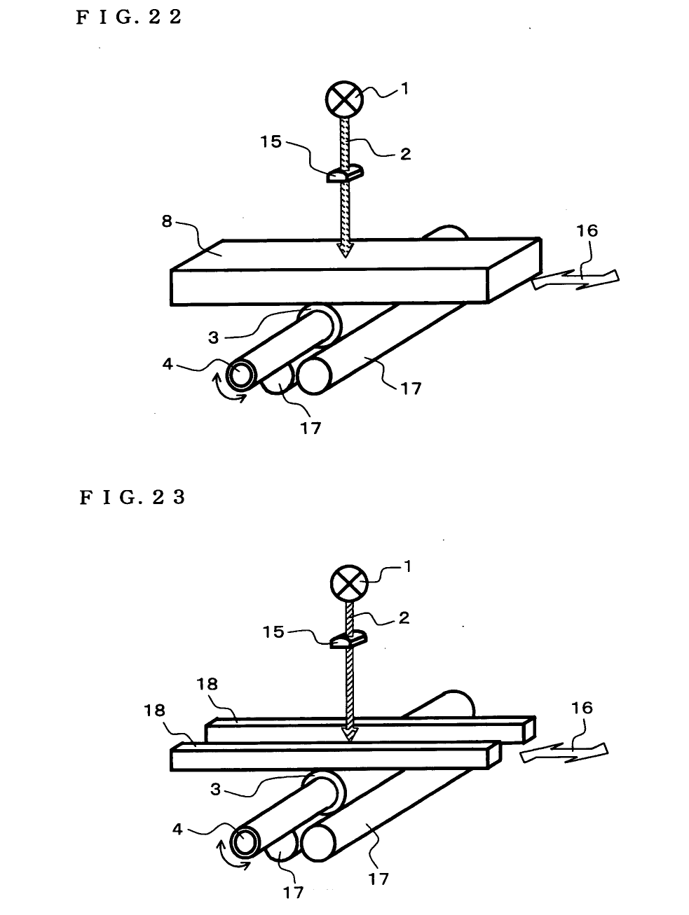

The welding device shown in FIG. 22 included, as the infrared irradiation source, a continuous oscillation type carbonic acid gas laser of a wavelength of 10.6 μm and a beam diameter of 4 mm was used. As heat releasing materials 8, a zinc selenide plate (ZnSe) of a thermal conductivity of 19 W/m·° C. at 27° C., double side anti-reflection coating, a carbonic acid gas laser transmittance of 99% and a thickness of 7 mm as well as a silicon plate (Si) of a thermal conductivity of 150 W/m·° C. at 27° C., a carbonic acid gas laser transmittance of 45% and a thickness of 1 mm were used. Two support rollers 17 of 7 mm diameter were used for supporters.

An infrared beam oscillated from the carbonic acid gas laser was passed through a cylindrical lens of a 100 mm focus length and adjusted to be an oval beam of about 4 mm long diameter with about 0.5 mm short diameter at the inserted region of the two tubes. The oval beam was directed such that the axial direction of the tubular region met with the long diameter direction of the beam.

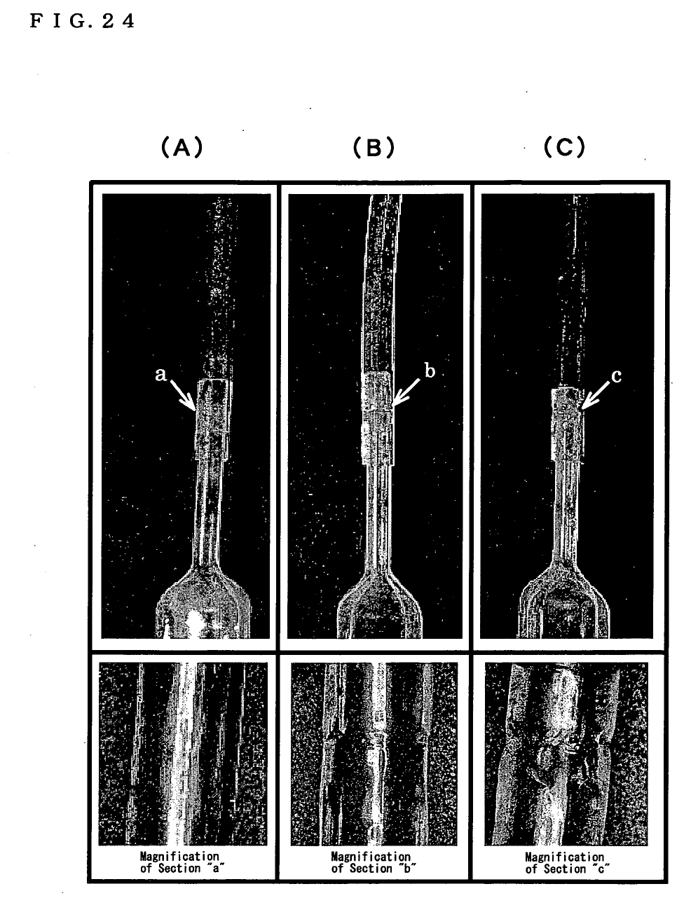

The sizes and the physical properties of the above-described resin casting with the partial tubular regions are shown in Table 1. Before setting of the resin casting to the welding device, the tubular region of the polyethylene resin casting (a carbonic acid gas laser light absorption coefficient of 1.0×10³ m⁻¹) was inserted into the tubular region of the polyolefin resin casting (a carbonic acid gas laser light absorption coefficient of 2.6×10³ m⁻¹). The length of the inserted regions was in a range from about 10 to 12 mm. As shown in FIG. 24A, the inserted regions were clamped between the solid heat releasing material and the two support rollers at a compression load of about 0.5 kgf (4.9 N). By moving the solid heat releasing material horizontally, the inserted regions were rotated with concurrent infrared irradiation from the laser. The solid heat releasing material was controlled to move in one horizontal direction at a constant mobile speed. The welding time was set equal to one rotation period of the inserted regions. Table 2 shows the particulars of the solid heat releasing material and the carbonic acid gas laser used for the welding.

Presence of generation of smoke was checked during welding and the product was taken out of the device for observation of the surface features, i.e. presence of any melting and thermal damages, by a digital microscope. For confirmation of successful welding, the inserted regions were subjected to a hermetic test. To this end, the end of the polyolefin tubular region was closed by welding. A hole was formed in the end of the polyethylene resin casting for supply of compressed air. The inserted regions were then immersed into a water bath to a depth of about 5 cm and, in this state, compressed air of 0.1 MPa pressure was supplied through the hole in the polyethylene resin casting over about 60 sec. Leakage of the compressed air through the inserted region was checked.

When hermetic test was applied to the inserted regions of the resin castings prior to welding, furious leakage of air through a gap in the inserted regions was observed. Presence of air leakage was indicative of success in welding.

As example 7 in Table 2 indicates, there was no generation of fire and smoke during welding with use of a heat releasing material made of zinc, selenide, a laser output of 22 W (constant) and a mobile speed of 40 mm/sec. No presence of melting and thermal damages was observed on the surface subjected to infrared irradiation. The welded region of example 7 is shown in FIG. 24B. The result of air leakage test endorsed complete success in welding.

Then, as example 8 in Table 2 indicates, welding was performed as in example 7 but with a reduced laser output of 5.5 W (constant) at a mobile speed of 5.5 mm/sec. No generation of fire and smoke was observed during welding and no presence of melting and thermal damages was observed on the surface subjected to infrared irradiation. The result of the hermetic test endorsed complete success in welding.

Next, as example 9 in Table 2 indicates, welding was performed as in example 7 but with a constant laser output of 22 W at a mobile speed of 20 mm/sec. No generation of fire and smoke was observed during welding and no presence of any melting and thermal damages was observed on the surface subjected to infrared irradiation. The result of the hermetic test endorsed complete success in welding.

### Comparative Examples 4 to 9

The resin casting combination was same as those in the foregoing examples but no heat releasing material was used in these comparative examples. An opening was formed in a fixed plate 18 for passage of infrared beam. The inserted regions of the resin casting was clamped between the fixed plate and the support roller 17 and the fixed plate was moved in one horizontal direction at a constant mobile speed during irradiation to rotate the inserted regions of the resin casting. The period of infrared irradiation was similar to one rotation of the inserted regions. As shown in Table 2, welding was performed at various mobile speeds of the fixed plate.

As shown in Table 2, welding was performed with a constant laser output of 22 W and mobile speeds in a range from 60 to 30 mm/sec. Generation of fire and smoke was observed during infrared irradiation in comparative examples 5 to 9 and presence melting and thermal damages was observed on the irradiated surface. One example of such a result is shown in FIG. 24C (comparative example 8). Results of the hermetic test indicated insufficient welding.

From the above-described examples 7 to 9, it is confirmed that application of the welding method in accordance with the present invention even to partially tubular resin casting affords excellent surface features and airtight welding without generation of any melting and thermal damages.

TABLE 1

| | | | Soft Polyolefin | Plyethylene |
|---|---|---|---|---|
| Particulars | | Unit | Tube | Casting |
| Tubular | Inner Dia. | mm | 2.7 | 1.0 |
| Region | Outer Dia. | mm | 3.4 | 3.0 |
| | Thickness | mm | 0.35 | 1.0 |

| | | | |
|---|---|---|---|
| Material | — | Ethylene- | Low-Density |
| | | α-Olefin | Polyethylene |
| | | Copolymer | |
| Density | kg/m³ | 865 | 920 |
| Specific Heat | J/k · ° C. | 2,600 | 2,200 |
| Thermal Conductivity | W/m · ° C. | 0.31 | 0.35 |
| Carbonic Acid Gas Laser | m⁻¹ | 2.6 × 10³ | 1.0 × 10³ |
| Light Absorption | | | |
| Coefficient | | | |
| Melting Point | ° C. | 52 | 105 |
| Shore A Hardness | (JIS K | 60 | — |
| | 6253) | | |

TABLE 2

| | | | Laser | Mobile | | | | |
|---|---|---|---|---|---|---|---|---|
| | | Heat Releasing | Output | Speed | | Irradiated Region | | Air |
| | | Material | W | mm/sec | Fire/Smoke | Melting | Thermal Damage | Leakage |
| Examples | 4 | Zinc Selenide | 22 | 40 | None | None | None | None |
| | | | | | | | (FIG. 24(B)) | |
| | 5 | Zinc Selenide | 5.5 | 7 | None | None | None | None |
| | 6 | Silicon | 22 | 20 | None | None | None | None |
| Comparative | 4 | None | 22 | 60 | None | None | None | Present |
| Examples | 5 | None | 22 | 55 | Observed | Present | Present | Present |
| | 6 | None | 22 | 50 | Observed | Present | Present | Present |
| | | | | | | | (V Recess) | |
| | 7 | None | 22 | 45 | Observed | Present | Present | Present |
| | | | | | | | (V Recess) | |
| | 8 | None | 22 | 40 | Observed | Present | Present | Present |
| | | | | | | | (V Recess) | |
| | | | | | | | (FIG. 24(C)) | |
| | 9 | None | 22 | 30 | Observed | Present | Present | Present |
| | | | | | | | (V Recess | |
| | | | | | | | Significant) | |

### INDUSTRIAL APPLICABILITY OF THE INVENTION

In accordance with the present invention, the surface temperature of a resin casting on the infrared irradiation side can be made lower than the softening temperature of the resin casting and, as a consequence, welding bead of excellent surface features and high welding strength can be manufactured without development of significant shrinkage and thermal damages on the welded surface.

1. A method for welding thermoplastic resin castings in which at least two infrared absorptive thermoplastic resin castings are overlapped and said overlapped resin castings are infrared irradiated for welding
characterized in
that relevant process temperatures are controlled in accordance with the following formulas;
Ts<Tma
Ti>Tm
wherein
Ts is the surface temperature of said resin casting on the infrared irradiation side,
Tma is the softening temperature of said resin casting on the infrared irradiation side,
Ti is the contact surface temperature between said resin castings and,
Tm is the softening temperature of said resin casting having the lowest softening temperature.

2. The method according to claim 1, characterized in that an infrared transmissive solid or liquid heat releasing material is combined in contact with one surface of said combined thermoplastic resin castings and that the infrared irradiation is carried out from the side of the heat releasing material.

3. The method according to claim 2, characterized in
that the infrared irradiation conditions are controlled in accordance with the following formula:
Ts₂>Ti₂≧Tm
wherein
Ts₂ is the surface temperature of said thermoplastic resin casting on the infrared irradiation side when said heat releasing material is not used,
Ti₂ is the contact surface temperature between said thermoplastic resin castings when said heat releasing material is not used, and
Tm is the softening temperature of said thermoplastic resin casting having the lowest softening temperature.

4. The method according to claim 2, characterized in that said heat releasing material has a solid infrared transmissive region in the wavelength range of said infrared radiation.

5. The method according to claim 4, characterized in that the thermal conductivity of said heat releasing material at 27° C. is 10 W/m·° C. or higher.

6. The method according to anyone of claims 1 to 5, characterized in that said infrared radiation is a laser beam generated by a carbonic acid gas laser.

7. The method according to one of claims 1 to 5, characterized in that said thermoplastic resin casting is infrared transmissive and requires no additional infrared absorptive heating assistant.

8-11. (canceled)
